(19) United States
(12) Patent Application Publication
(10) Pub. No.: US 2011/0007951 A1
(43) Pub. Date: Jan. 13, 2011

(54) SYSTEM AND METHOD FOR IDENTIFICATION OF FINGERPRINTS AND MAPPING OF BLOOD VESSELS IN A FINGER

(75) Inventors: Samson Mil'shtein, Chelmsford, MA (US); Michael Baier, Lowell, MA (US); Anup Pillai, Lowell, MA (US); Ameya M. Shendye, West Haven, CT (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: University of Massachusetts Lowell, Lowell, MA (US)

(21) Appl. No.: 12/777,624

(22) Filed: May 11, 2010

Related U.S. Application Data
(60) Provisional application No. 61/177,095, filed on May 11, 2009.

(51) Int. Cl. G06K 9/00; H04N 7/18

(52) U.S. Cl. 382/124; 348/77; 348/E07.085

(57) ABSTRACT

In accordance with an embodiment of the invention, there is provided an apparatus for characterizing and identifying a human. The apparatus comprises a light imaging device that images topography of a surface of a portion of human anatomy, and an infrared imaging device that images infrared radiation of the same portion of human anatomy. The light imaging device and the infrared imaging device are rotatable about at least one axis, each of the at least one axis extending through the portion of the anatomy.

### RELATED APPLICATION

This application claims the benefit of U.S. Provisional Application No. 61/177,095, filed on May 11, 2009. The entire teachings of the above application are incorporated herein by reference.

### BACKGROUND OF THE INVENTION

Fingerprints are the most common biometric measure taken, and in recent years electronic fingerprint scanning has become commonplace. Although contactless fingerprinting methods are used, it is more common that the fingerprint is taken by pressing the finger against a computer scanner. Fingerprint image acquisition is considered the most critical step of an automated fingerprint authentication system as it determines the final fingerprint image quality which has drastic effects on overall system performance. Not long ago, the “wet ink technique” was widely used to obtain fingerprints. With that method the finger was dipped in ink and then pressed against the paper.

Currently on the market there are different types of computer scanners used as fingerprint readers, but the basic idea behind each scanner is to capture and store the fingerprint pattern with sufficient detail that the ridgeflow and minutia are useful for later comparison with other known prints. The procedure to capture a fingerprint using a sensor consists in rolling or pressing a finger against the sensing area. The sensor itself can operate based on a variety of different principles, such as measurements of electrical resistance of a tested finger and imaging based on thermal or charge coupling devices.

Concerns regarding the creation of finger decoys by groups of criminals and terrorists have prompted the development of blood vessel mapping technology, which is expected to replace the conventional fingerprinting technology. A finger vein scanner has been developed that maps the blood vessels of the finger [2]. Such biometric systems record subcutaneous infrared absorption patterns to produce unique and private identification templates for users. Veins and other subcutaneous features present robust, stable and largely hidden patterns. An advantage of vein mapping systems is that the human vascular system is a unique and private feature of an individual. Even identical twins have different and distinct infrared absorption patterns. The vein patterns are not directly observed and therefore not easily replicated. Only if a person's finger is cut off will the vein pattern cease to exist. However, questions still remain as to whether a person's vascular pattern may be a subject of modification due to medical conditions, level of personal smoking, or as simple a factor as hand temperature.

Having a spoof detection system [3] in conjunction with a computer scanner defeats the purpose of reading a non-distorted fingerprint since the finger is pressed against the glass surface of a scanner. The magnitude and direction of the pressure applied to the finger and presence of contamination on the skin introduce distortion, noise, and inconsistencies of the captured fingerprint image. Due to variable pressure, the representation of the same fingerprint changes every time the finger is placed on the sensor's surface, thereby increasing the complexity of fingerprint identification.

United States Patent Application Publication No. 2007/0177767 [9] describes a user friendly compact system that is used for capturing a vein pattern in a finger. The method involves contact of the finger with the surface. The method operates in reflection mode, where the emitter and detector are on the same side. U.S. Pat. No. 5,751,835 [10] describes capturing capillaries in a fingernail using fibers. The method involves contact of the object with a surface and works in reflection mode. United States Patent Application Publication No. 2007/0058841A1 [11] describes a system embedded in a door knob that captures vein images in finger. The system works in the transmission mode but the camera is on the opposite side from the palm side of the hand. The method involves contact with the surface. United States Patent Application Publication No. 2005/0047632A1 [12] acquires a vein pattern in the finger using a transmission mode of operation. U.S. Pat. No. 7,266,223 B2 [13] describes vein pattern acquisition in transmission mode with positioning of the finger being partially by contact and partially without contact.

The teachings of all references cited herein are incorporated by reference in their entirety.

### SUMMARY OF THE INVENTION

In accordance with an embodiment of the invention, there is provided an apparatus for characterizing and identifying a human. The apparatus comprises a light imaging device that images topography of a surface of a portion of human anatomy, and an infrared imaging device that images infrared radiation of the same portion of human anatomy, the light imaging device and the infrared imaging device being rotatable about at least one axis, each of the at least one axis extending through the portion of the anatomy.

In related embodiments, the light imaging device may be rotatable whereby imaging of the topography is oriented essentially normal to a light imaging plane at the surface of the portion of human anatomy being imaged at each sequential image during imaging of the topography. The infrared imaging device may be rotatable whereby imaging of the infrared radiation is oriented essentially normal to an infrared imaging plane at the surface of the portion of human anatomy being imaged at each sequential image during imaging of the infrared radiation. The portion of human anatomy may comprise a finger, the topography of the surface comprising at least a portion of a fingerprint. The infrared radiation may comprise infrared radiation emitted by at least a portion of a network of blood vessels of the finger. The light imaging device may comprise a line scanning camera; and the infrared imaging device may comprise an infrared camera. The apparatus may further comprise a motor, the light imaging device and the infrared imaging device being rotated around the finger as they are coupled to the shaft of the motor (rotatably coupled to a shaft of the motor). A motor controller circuit may be electronically coupled to the motor. An imaging device trigger circuit may be electronically coupled to at least one of the light imaging device and the infrared imaging device. The imaging device trigger circuit may comprise at least one of a frame trigger circuit and a line trigger circuit. The apparatus may comprise a light source that emits light onto the surface of the portion of human anatomy; and an infrared emission source that emits infrared radiation onto the portion of human anatomy. The light source may emit white light onto the surface of the portion of human anatomy; and the infrared emission source may emit near infrared radiation onto the portion of human anatomy.

In further related embodiments, the apparatus may further comprise an image processor electronically coupled to at least one of the light imaging device and the infrared imaging device. The image processor may comprise at least one of a Fourier Transform processor and a Fast Fourier Transform processor; and may comprise a fingerprint data processing module and/or a blood vessel data processing module. The apparatus may comprise only one light imaging device. The light imaging device may be rotatable whereby imaging of the topography produces a nail to nail electronic fingerprint image. The apparatus may comprise a contactless fingerprinting device. The apparatus may comprise a contactless blood vessel mapping device of the portion of human anatomy, such as a finger.

In another embodiment according to the invention, there is provided a method for characterizing and identifying a human. The method comprises the steps of rotating a light imaging device about an axis extending through a portion of human anatomy, whereby a composite surface image is formed of sequential images obtained while the light imaging device is oriented essentially normal to a plane at the surface of the anatomy at each sequential image; and rotating an infrared imaging device about the same axis, whereby a composite thermal image is obtained while the infrared imaging device is oriented essentially normal to a plane at the surface of the anatomy at each sequential image.

In further, related embodiments, the portion of human anatomy may comprise a finger, and the composite surface image may comprise at least a portion of a fingerprint. The composite thermal image may comprise at least a portion of a network of blood vessels of the finger. The rotating the light imaging device may comprise rotating a line scanning camera about the axis. The rotating the infrared imaging device may comprise rotating an infrared camera about the axis. The rotating the light imaging device about the axis and the rotating the infrared imaging device may comprise rotating the devices using a motor. The method may comprise controlling the motor with a motor controller circuit. The method may comprise triggering at least one of the light imaging device and the infrared imaging device with an imaging device trigger circuit. At least one of an image frame and an image line may be triggered with the imaging device trigger circuit. The method may comprise emitting light with a light source onto the surface of the portion of human anatomy; which may comprise emitting white light onto the surface of the portion of human anatomy. The method may comprise emitting infrared radiation onto the portion of human anatomy with an infrared emission source; which may comprise emitting near infrared radiation onto the portion of human anatomy.

In further related embodiments, the method may comprise electronically processing an image of the anatomy from at least one of the light imaging device and the infrared imaging device to compare the image of the anatomy with another image of a similar portion of human anatomy. The electronically processing the image may comprise performing at least one of an electronic Fourier Transform processing and an electronic Fast Fourier Transform processing. The method may comprise electronically processing an image of at least a portion of a fingerprint. The method may comprise electronically processing an image of at least a portion of a network of finger blood vessels. The method may comprise rotating only one light imaging device about the axis. The method may comprise rotating the light imaging device about the axis to produce a nail to nail electronic fingerprint image. The light imaging device may be rotated to produce an electronic fingerprint image without mechanically contacting the fingerprint area of a finger. The method may comprise rotating the infrared imaging device to produce a composite thermal image of at least a portion of a network of blood vessels of the portion of human anatomy, such as a finger, without mechanically contacting the finger.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a diagram of an apparatus for line scanning and thermal imaging of a finger or other portion of anatomy, in accordance with an embodiment of the invention.

FIG. 2 is an image of a line scan fingerprint acquired by an apparatus in accordance with an embodiment of the invention.

FIG. 3 is an image of a pre-processed blood vessel image acquired by an apparatus in accordance with an embodiment of the invention.

FIG. 4 is a block diagram of a fingerprint acquisition process in accordance with an embodiment of the invention.

FIG. 5 is a block diagram of implementation of a line scan algorithm (LSA) for electronic image data analysis in accordance with an embodiment of the invention.

### DETAILED DESCRIPTION OF THE INVENTION

A description of example embodiments of the invention follows.

There is a significant drawback with almost all contactless scanners on the market today. The contactless method introduced in [4] has multiple cameras positioned at 45° relative to each other, but this method is complicated and limited in accuracy. While an image of the flat portion of the finger is obtained without any distortion, the rounded edges of the finger are not perpendicular to the imager, and thus their projection on the flat surface of the sensing element creates distortion. This distortion increases the further out the segment is from being perpendicular. To correct the distortion coming from the side of the finger mathematical processing was developed to convert the three dimensional fingerprint images into two dimensional ones. However, this image processing in addition to be very complex did not correct the problem completely.

United States Provisional Patent Application No. 60/840,555 [6] describes how the three dimensional image of a finger is recorded in pixel-thick lines by scanning the camera around the finger in a circular manner. The line scan camera rotates 180 degrees about the finger and then displays the image in a few seconds. The final image captures an uncoiled view of the finger. The developed method is the most direct conversion of three dimensional images into two dimensional images. The resolution of the images taken by the camera is 2048×2048, but that can be increased to 2048×32,767 or other higher resolutions. The physical size of the pixel thick line is, for example, 1.9 μm. Such high precision allows seeing the ridges in great detail and even pores in the skin. These pores and ridges, known as level 3 features, and visible in the images captured by the system, could be used for fingerprint matching [7-8]. However, in the line scanning technique of U.S. Provisional Patent Application No. 60/840,550, filed on Sep. 19, 2006, unstable position of a tested finger and variation of light reflected from a finger caused errors in recognition procedure.

In accordance with an embodiment of the present invention, a contactless technique is provided that makes use of the very promising attributes of line scanning technology. Line scanning views each portion of the finger perpendicularly, thereby removing the projection errors of conventional flat scanning In accordance with an embodiment of the present invention, a single device performs both line scanning of a fingerprint and blood vessel mapping by infrared imaging, quickly and with high resolution and accuracy of identification and without requiring contact of the fingerprint area to a sensor surface. The three dimensional image of a finger is recorded in pixel-thick lines by scanning the camera around the finger. The final image captures an uncoiled view of the finger. The system performs a line scanning of finger ridges in conventional light while the camera rotates in one direction around the finger, and then performs an infrared light imaging of the blood vessels as the camera returns in the other direction to its original position, thereby creating a blood vessel map of the finger. The fingerprint image and the blood vessel image may be used for biometric identification. Such a system may also be used for other anatomical features in addition to fingers, for example for face recognition, in which a comparison of major anthropometric lines may immunize the recognition system against benign cosmetics as well as intentional efforts to defeat such systems through the use of make-up or plastic surgery.

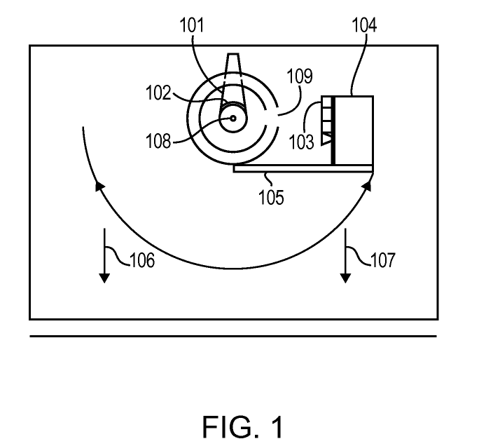

FIG. 1 is a diagram of an apparatus for line scanning and thermal imaging of a finger or other portion of anatomy, in accordance with an embodiment of the invention. A holder 101 provides a space for a finger (not shown) to be inserted into the apparatus. The holder 101 may provide an oval shape for the finger and may stabilize the position of the finger from above the finger. In order to permit visualization of blood vessels, an infrared emission source such as a set of near infrared light emitting diodes (LED's) 102 are mounted in the holder, above and along the line of the finger. The infrared emission source 102 may emit light in a near infrared wavelength range, for example at about a 625 nm wavelength. In this setting the finger may be seen in infrared light that is transmitted through the finger. The intensity of the emitted infrared light may be sufficient to produce an image with reasonable contrast in a normal CCD camera, for example an intensity of about 37 lumens. An infrared imaging device such as a small camera 103 may be used to image the transmitted infrared light to be used for vein mapping. In addition, a light source such as a halogen light source (not shown) may be used to illuminate the finger with visible light, which may, for example, be white light or daylight. This illumination permits fingerprint mapping using a light imaging device, such as a line scan camera 104, which is mounted on the same rotating lever 105 as the small camera 103 that is used for vein mapping. During a clockwise rotation 106 of the lever 105, the halogen light source is turned on and the line scan camera 104 is used to record a fingerprint image in visible light. Then, during a counterclockwise rotation 107 of the lever 105, the infrared emission source 102 is turned on and the small camera 103 is used for mapping blood vessels under the infrared illumination. The apparatus includes a finger positioner 108, which may be a small round-tip needle, to assist a subject in positioning the finger by contacting the tip of the positioner 108. An optical window 109 may rotate with the lever 105, to permit imaging of the illuminated finger by the cameras 103 and 104. In addition, the apparatus includes a motor (not shown) for rotating the lever 105. The motor may be mechanically coupled to the lever 105 using pulleys. Direct drive of the lever 105 by the motor may be used in order to simplify the design and make the operation of the machine more reliable. The motor is electronically connected to motor control circuitry, which is electronically connected to a computer that toggles parallel port pins (or other device interface ports) in order to execute a controller program. The controller program may electronically control the motor when to start and stop and control how many steps it should take during the image acquisition process. Separate imaging device trigger circuitry, such as frame trigger and line trigger circuitry, provides triggering signals to the cameras 103 and 104, and separate light source trigger circuitry provides on/off signals and intensity signals to the halogen light source and the infrared emission source (such as near infrared light source 102). The camera trigger circuitry and light source trigger circuitry may be connected to the computer using device interface ports, and may be coordinated with the operation of the motor control circuitry so that the movement of the lever 105, the turning on and off of the cameras 103 and 104, and the turning on an off and intensity levels of the halogen light source and the infrared emission source 102 is coordinated as desired. In particular, during clockwise rotation 106 the line scan camera 104 and halogen light may be on while the infrared camera 103 and near infrared emission source 102 are off, and the line scan camera 104 takes the fingerprint image in visible light. The halogen light source may emit light at an appropriate intensity to permit acquisition of the fingerprint image. Then, during counterclockwise rotation 107, the line scan camera 104 and halogen light source may be off while the infrared camera 103 and infrared emission source 102 are on, and the infrared camera 103 acquires in infrared light at regular intervals the image frames that may be used to construct the vein map of the finger. The electronic image data from both the line scan camera 104 and 103 may be stored in the cameras and/or immediately transferred to a computer for subsequent electronic image data processing. The infrared emission source 102 may emit light at an appropriate intensity to permit acquisition of the infrared image. In addition, the infrared camera 103 (or another small camera mounted above the line scan camera 104), may be used to look directly inside the hollow space where the finger is inserted and to transmit a visual image of the finger to a monitor that may be displayed to the person whose finger is being imaged. This provides safe operation and allows the user to be aware of the stages of scanning and to be aware of the orientation and position of their finger when image acquisition is in progress.

In accordance with an embodiment of the invention, the near infrared light used for thermal imaging may, for example, be in the wavelength range of 620 nm to 800 nm, although other wavelengths may be used. The visible light used for line scan imaging may, for example, be white light or daylight, although other wavelengths may be used. The holder device 101 may be made of glass or another material, and may include a palm support (not shown) for a user's hand, and/or a flat support for the base of a user's finger. The intensity of light from the halogen light source or infrared emission source may be controlled by light intensity control circuitry (which in turn may be electronically controlled by a computer), such that the intensity level is adjusted depending on the reflective qualities of the finger. For example, a finger that is greasy may have a different reflective quality than one that is clean, and therefore may be better imaged with a higher or lower intensity of light. It will be appreciated that the line scan imaging and the thermal imaging may be performed in either order (one before or after the other). The infrared camera 103 need not be a line scanning camera, although a line scanning infrared camera could be used. In accordance with an embodiment of the invention, the imaging of both the infrared camera 103 and the line scan camera 104 may be from nail to nail of the finger; thus, a contactless, nail to nail image of a fingerprint may be obtained with a single camera, and a contactless nail-to-nail thermal image of blood vessels may be obtained in the same device.

In accordance with an embodiment of the invention, the system may be completely automated. The automation may use software programs installed on the control computer connected as described above, or on another computer that receives electronic image data from the cameras of the apparatus of FIG. 1. For example, programs such as MATLAB® may be used for image processing once the images are acquired by the cameras and transmitted to the computer. (MATLAB® is a trademark of TheMathWorks, Inc. of Natick, Mass., U.S.A.). Programs such as LabVIEW™ may be used to permit acquisition by the computer of the electronic image data acquired by the cameras. (LabVIEW™ is a trademark of National Instruments Corporation of Austin, Tex., U.S.A.). These image processing and acquisition programs may be coordinated, by the computer, with motor control, camera trigger and light source trigger circuitry. As soon as the finger is in position, the “Scan” button on the Front Panel of the LabVIEW program may be pressed. Immediately, the camera rotates using lever 105 and in a few seconds the image is displayed on screen. MATLAB may then take over and compare the newly acquired image to a database of electronic finger image data stored in memory. The result of the comparison is displayed within few seconds. Automation that includes use of the LabVIEW and MATLAB modules may involve the computer toggling the status of its parallel ports.

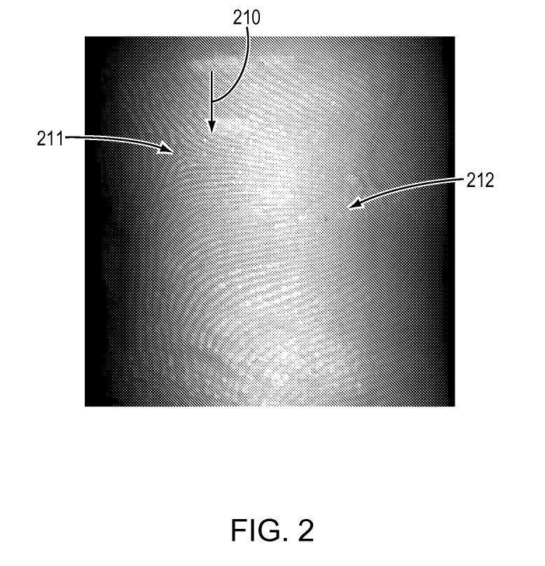

FIG. 2 is an image of a line scan fingerprint acquired by an apparatus in accordance with an embodiment of the invention. High resolution images may be obtained with no pressure-induced distortion. The view of the flat portion and sides of the finger that is taken by the rotating cameras is always perpendicular to the finger surface, at each successive image during imaging. Therefore, deviation of the finger shape from the ideal cylinder does not create significant distortion. This avoids the projection errors of conventional flat scanning Separate features seen in FIG. 2 are micron-size individual pores on the skin. A direction of scan 210 is from top to bottom of the page in FIG. 2. A delta 211 and a core 212 feature of the fingerprint may be seen. The three dimensional image of the finger is recorded in pixel-thick lines by the scanning of the camera around the finger in a circular manner. The final image captures an uncoiled view of the finger. The resolution of the images taken by the camera may be 2048×1024, 2048×32,767 or a higher resolution. The physical size of the pixel-thick lines may, for example, be 1.9 μm. Such high precision allows the ridges in great detail and even pores in the skin to be seen.

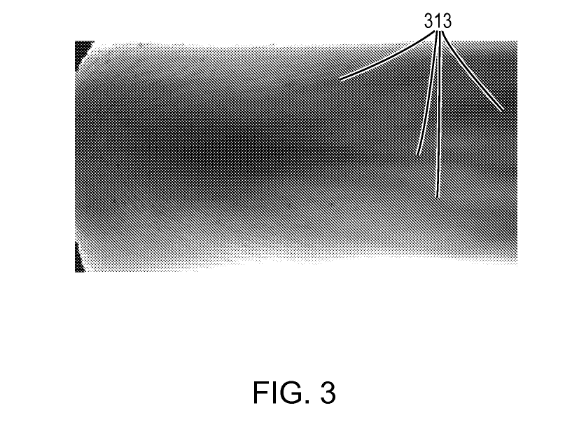

FIG. 3 is an image of a pre-processed blood vessel image acquired by an apparatus in accordance with an embodiment of the invention. The blood vessels 313 may be seen. The set of partial images (image clusters) acquired by the infrared camera may be uncoiled to provide such a 180° view of veins in a finger. A cluster scan algorithm or other electronic image data processing may be implemented to identify the finger.

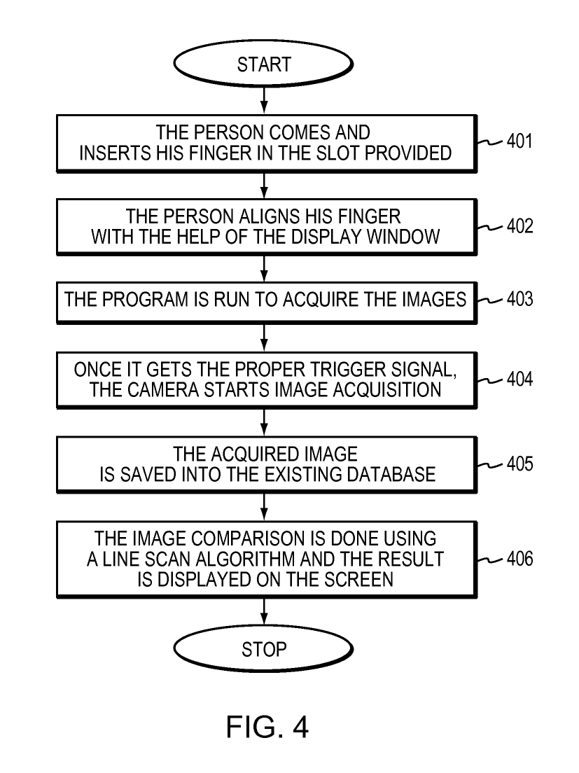

FIG. 4 is a block diagram of a fingerprint acquisition process in accordance with an embodiment of the invention. In step 401, the person whose fingerprint is to be acquired inserts his or her finger into the slot provided. In step 402, the person aligns the finger in the device using a display window such as a window on a monitor that displays an image of the finger from which its position can be determined. In step 403, the program is run to acquire the images. In step 404, once the camera obtains the proper trigger signal, it begins image acquisition. In step 405, the acquired image is electronically transferred to a computer and saved into a database of acquired fingerprint images. In step 406, an electronic image comparison is performed using an algorithm such as the Line Scan Algorithm (LSA), and the result is displayed on a monitor. The result may, for example, be an electronic indication of a match or lack of match between the acquired image and one that has previously been obtained, and/or an indication of the extent of similarity of the match.

In accordance with an embodiment of the invention, an apparatus for fingerprint and vein mapping identification may provide electronic image data to an image processor (such as by electronic transfer via a parallel port or other device interface of a computer) that may implement one or more image recognition algorithms. The image processor may be electronically coupled to at least one of the light imaging device and the infrared imaging device. The image processor may comprise a Fourier Transform processor, a Fast Fourier Transform processor, a fingerprint data processing module, and/or a blood vessel data processing module. All of the foregoing processors may be implemented by a specially programmed computer for performing the image processing. The image recognition algorithms may include the Spaced Frequency Transformation Algorithm (SFTA) and the Line Scan Algorithm (LSA), either or both of which may be performed to analyze electronic image data of fingerprints and/or of blood vessels. Such algorithms are disclosed in “Fingerprint Recognition Algorithms for Partial and Full Fingerprints,” 2008 IEEE Conference on Technologies for Homeland Security, 449-452, the disclosure of which is hereby incorporated herein by reference in its entirety. The SFTA algorithm may be particularly useful for partial fingerprints, and is based on taking the Fast Fourier Transform of the images. A combination of the SFTA and LSA algorithms provides a very efficient recognition technique. The SFTA follows the frequency of the ridge patterns and the LSA is based on a correlation function.

In the SFTA algorithm implemented in accordance with an embodiment of the invention, a computer or other electronic image data processor first reads all the images from a database. The ridges are made more distinguishable by using a log filter, and then the two-dimensional Fast Fourier Transform of the images to be compared is computed. The Fast Fourier Transforms of the images to be compared may be shifted so that the DC components of each are positioned in the center of each Fast Fourier Transform of the image. The Fast Fourier Transforms of the images are then scanned with respect to rows and columns, and compared to find whether similar pixel intensity values are found at each corresponding row/column point. If a similar pixel intensity value is found then a counter is incremented. If this count exceeds a threshold, the prints are declared a match.

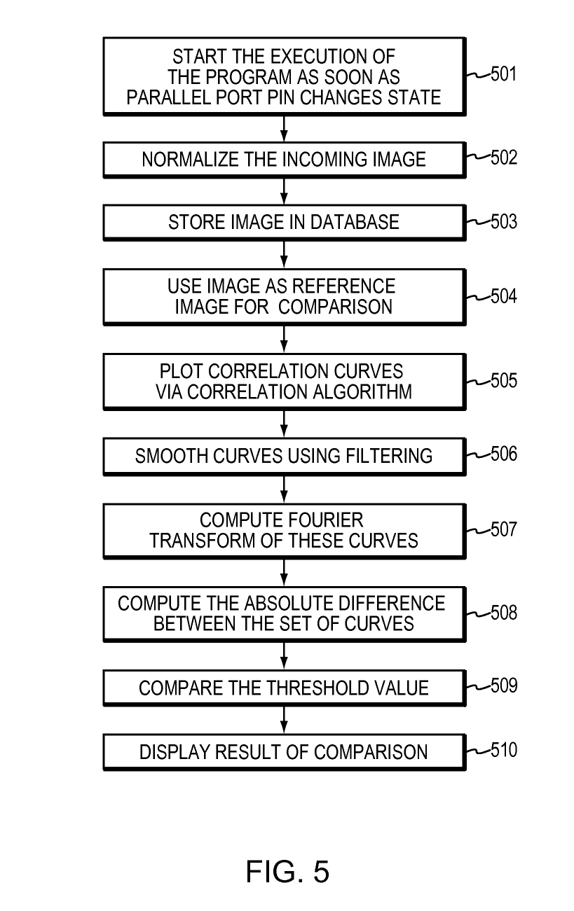

FIG. 5 is a block diagram of implementation of a line scan algorithm (LSA) for electronic image data analysis in accordance with an embodiment of the invention. A computer or other electronic image data processor may start execution 501 as soon as a parallel port pin toggles its state. The incoming image is normalized 502 and stored 503 in a database. A subroutine crops out the unwanted information present in the image. The program boundaries of the images undergoing comparison and then resizes the images in such a manner that the tested areas are of equal dimensions. The incoming image is used as the reference image for comparison, at 504. At 505, the correlation curves are found that correspond to the row intensities for the compared images. The symmetry of the correlation function is used to judge the final result of the comparison. These curves are very similar for the same fingerprints and are much different for dissimilar fingerprints. The curves are smoothed at 506. The similarity between the curves is defined in the frequency domain by taking a Fourier transform 507, computing the absolute difference between the set of curves 508, and comparing the result 509 to a threshold value to see if the prints are from the same finger. The result of the analysis may be displayed at 510, for example, as an electronic indication of a match or lack of match between the acquired image and one that has previously been obtained, and/or an indication of the extent of similarity of the match.

An embodiment according to the invention permits contactless fingerprinting and contactless mapping of blood vessels in a single apparatus. The apparatus may be used to recognize partial fingerprints. The apparatus may be used for biometric systems in a wide variety of different possible settings, including for financial transaction and for security procedures implemented by governmental and private entities, such as for airport security, individual control of personal computers and for installation as perimeter control devices in private companies or governmental agencies. Although fingerprints have been discussed herein, other topographical features of the human anatomy may analyzed. Although FIG. 1 shows the line scanning camera 104 and small camera 103 rotating about a common axis that extends through a portion of the finger, it is also possible that the two devices could rotate about different axes, each of which extends through a portion of the finger. By virtue of the rotation about the finger in FIG. 1, images may be acquired that are essentially normal to a light imaging plane at the surface of the portion of human anatomy being imaged at each sequential image during imaging of the topography, and that are essentially normal to an infrared imaging plane at the surface of the portion of human anatomy being imaged at each sequential image during imaging of the topography.

A system in accordance with an embodiment of the invention may use systems and methods disclosed in “Line Scanner for Biometric Applications,” 2008 IEEE Conference on Technologies for Homeland Security, 205-208, the disclosure of which is hereby incorporated herein by reference in its entirety. Further, a system in accordance with an embodiment of the invention may use systems and methods disclosed in Published PCT Application WO/2008/153539, entitled “Circumferential Contact-Less Line Scanning of Biometric Objects,” the disclosure of which is hereby incorporated herein by reference in its entirety.

### REFERENCES AND NOTES

The teachings of all patents, published and non-published applications and references cited herein are incorporated by reference in their entirety.
[1] Mil'shtein S, Doshi U, “Scanning of the pressure-induced distortion of fingerprints” Scanning, 26, 4, pp: 323-327, 2004
[2] http://www.pinktentacle.com/2007/07/hitachi-finger-vein-money/
[3] Nixon K. A., Rowe R. K., “Multispectral Fingerprint Imaging for Spoof Detection,” Proc. SPIE Conf Biometric Technology for Human Identification, pp: 214-225, 2005.
[4] Yi Chen, Geppy Parziale, Eva Diaz-Santana, and Anil K. Jain, ‘3D Touchless Fingerprints: Compatibility with Legacy Rolled Images’
[5] Parziale G., Diaz-Santana E., “3D Touchless Fingerprints: Compatibility with Legacy Rolled Images” Proc. Intl Conf. Biometrics, pp. 244-250, 2006
[6] S. Mil'shtein, J. Palma and C. Liessner “Circumferential Contact-less Line Scanning of Biometric Objects” patent appl. # 60/840,550 filed on Sep. 19, 2006
[7] Jain A. K., Chen Y., Demirkus M., “Pores and Ridges: High-Resolution Fingerprint Matching Using Level 3 Features” IEEE Transactions on Pattern Analysis and Machine Intelligence, 29, 1, pp: 15-27, 2007
[8] Xia X., O'Gorman L., “Innovations in Fingerprint Capture Devices” Pattern Recognition, 36, 2, pp: 361-369, 2003
[9] Biometric information Processing Device and Biometric Information Processing Program, Miura et. All, US patent # 2007/0177767
[10] Method and Apparatus for the Automated Identification of Individuals by the nail beds of their fingers, Topping et. All, patent # US005751835A
[11] Personal Identification Device and Method, Miura et al., patent # US 2007/0058841A1
[12] Personal Identification Device and Method, Miura et al., patent # US 2005/0047632A1
[13] Personal Identification Device and Method, Miura et al., U.S. Pat. No. 7,266,223 B2

While this invention has been particularly shown and described with references to example embodiments thereof, it will be understood by those skilled in the art that various changes in form and details may be made therein without departing from the scope of the invention encompassed by the appended claims.

What is claimed is:

1. An apparatus for characterizing and identifying a human, comprising:
a) a light imaging device that images topography of a surface of a portion of human anatomy; and
b) an infrared imaging device that images infrared radiation of the same portion of human anatomy, the light imaging device and the infrared imaging device being rotatable about at least one axis, each of the at least one axis extending through the portion of the anatomy.

2. An apparatus according to claim 1, the light imaging device being rotatable whereby imaging of the topography is oriented essentially normal to a light imaging plane at the surface of the portion of human anatomy being imaged at each sequential image during imaging of the topography.

3. An apparatus according to claim 2, the infrared imaging device being rotatable whereby imaging of the infrared radiation is oriented essentially normal to an infrared imaging plane at the surface of the portion of human anatomy being imaged at each sequential image during imaging of the infrared radiation.

4. An apparatus according to claim 1, wherein the portion of human anatomy comprises a finger, the topography of the surface comprising at least a portion of a fingerprint.

5. An apparatus according to claim 4, wherein the infrared radiation comprises infrared radiation emitted by at least a portion of a network of blood vessels of the finger.

6. An apparatus according to claim 1, wherein the light imaging device comprises a line scanning camera.

7. An apparatus according to claim 6, wherein the infrared imaging device comprises an infrared camera.

8. An apparatus according to claim 1, further comprising a motor, the light imaging device and the infrared imaging device being rotatably coupled to a shaft of the motor.

9. An apparatus according to claim 8, further comprising a motor controller circuit electronically coupled to the motor.

10. An apparatus according to claim 9, further comprising an imaging device trigger circuit electronically coupled to at least one of the light imaging device and the infrared imaging device.

11. An apparatus according to claim 10, wherein the imaging device trigger circuit comprises at least one of a frame trigger circuit and a line trigger circuit.

12. An apparatus according to claim 1, further comprising a light source that emits light onto the surface of the portion of human anatomy.

13. An apparatus according to claim 12, further comprising an infrared emission source that emits infrared radiation onto the portion of human anatomy.

14. An apparatus according to claim 13, wherein the light source emits white light onto the surface of the portion of human anatomy.

15. An apparatus according to claim 14, wherein the infrared emission source emits near infrared radiation onto the portion of human anatomy.

16. An apparatus according to claim 1, further comprising an image processor electronically coupled to at least one of the light imaging device and the infrared imaging device.

17. An apparatus according to claim 16, wherein the image processor comprises at least one of a Fourier Transform processor and a Fast Fourier Transform processor.

18. An apparatus according to claim 16, wherein the image processor comprises a fingerprint data processing module.

19. An apparatus according to claim 18, wherein the image processor comprises a blood vessel data processing module.

20. An apparatus according to claim 1, wherein the apparatus comprises only one light imaging device.

21. An apparatus according to claim 1, wherein the light imaging device is rotatable whereby imaging of the topography produces a nail to nail electronic fingerprint image.

22. An apparatus according to claim 1, wherein the apparatus comprises a contactless fingerprinting device.

23. An apparatus according to claim 22, wherein the apparatus comprises a contactless blood vessel mapping device of a finger.

24. An apparatus according to claim 1, wherein the apparatus comprises a contactless blood vessel mapping device of the portion of human anatomy.

25. A method for characterizing and identifying a human, comprising the steps of:
a) rotating a light imaging device about an axis extending through a portion of human anatomy, whereby a composite surface image is formed of sequential images obtained while the light imaging device is oriented essentially normal to a plane at the surface of the anatomy at each sequential image; and
b) rotating an infrared imaging device about the same axis, whereby a composite thermal image is obtained while the infrared imaging device is oriented essentially normal to a plane at the surface of the anatomy at each sequential image.

26. A method according to claim 25, wherein the portion of human anatomy comprises a finger, the composite surface image comprising at least a portion of a fingerprint.

27. A method according to claim 26, wherein the composite thermal image comprises at least a portion of a network of blood vessels of the finger.

28. A method according to claim 25, wherein the rotating the light imaging device comprises rotating a line scanning camera about the axis.

29. A method according to claim 28, wherein the rotating the infrared imaging device comprises rotating an infrared camera about the axis.

30. A method according to claim 25, wherein the rotating the light imaging device about the axis and the rotating the infrared imaging device comprise rotating the devices using a motor.

31. A method according to claim 30, further comprising controlling the motor with a motor controller circuit.

32. A method according to claim 31, further comprising triggering at least one of the light imaging device and the infrared imaging device with an imaging device trigger circuit.

33. A method according to claim 32, further comprising triggering at least one of an image frame and an image line with the imaging device trigger circuit.

34. A method according to claim 25, further comprising emitting light with a light source onto the surface of the portion of human anatomy.

35. A method according to claim 34, further comprising emitting infrared radiation onto the portion of human anatomy with an infrared emission source.

36. A method according to claim 35, comprising emitting white light onto the surface of the portion of human anatomy.

37. A method according to claim 36, comprising emitting near infrared radiation onto the portion of human anatomy.

38. A method according to claim 25, further comprising electronically processing an image of the anatomy from at least one of the light imaging device and the infrared imaging device to compare the image of the anatomy with another image of a similar portion of human anatomy.

39. A method according to claim 38, wherein the electronically processing the image comprises performing at least one of an electronic Fourier Transform processing and an electronic Fast Fourier Transform processing.

40. A method according to claim 38, comprising electronically processing an image of at least a portion of a fingerprint.

41. A method according to claim 40, comprising electronically processing an image of at least a portion of a network of finger blood vessels.

42. A method according to claim 25, comprising rotating only one light imaging device about the axis.

43. A method according to claim 25, comprising rotating the light imaging device about the axis to produce a nail to nail electronic fingerprint image.

44. A method according to claim 25, comprising rotating the light imaging device to produce an electronic fingerprint image without mechanically contacting the fingerprint area of a finger.

45. A method according to claim 44, comprising rotating the infrared imaging device to produce a composite thermal image of at least a portion of a network of blood vessels of the finger without mechanically contacting the finger.

46. A method according to claim 25, comprising rotating the infrared imaging device to produce a composite thermal image of at least a portion of a network of blood vessels of the portion of human anatomy without mechanically contacting the portion of human anatomy.
